(19) United States
(12) Patent Application Publication
(10) Pub. No.: US 2002/0039663 A1
(43) Pub. Date: Apr. 4, 2002

(54) Metal fiber sheet and method of making same

(76) Inventor: Homan B. Kinsley JR., Powhatan, VA (US)

Correspondence Address: E. Joseph Gess, BURNS, DOANE, SWECKER & MATHIS, L.L.P., P.O. Box 1404, Alexandria, VA, 22313-1404, US

(21) Appl. No.: 09/950,642

(22) Filed: Sep. 13, 2001

Related U.S. Application Data
(63) Continuation of application No. 08/829,313, filed on Mar. 31, 1997, now abandoned.

(51) Int. Cl. B32B 15/02

(52) U.S. Cl. 428/605; 419/24; 419/2

(57) ABSTRACT

Provided by the present invention is a process for making a wet-layed metal fiber nonwoven sheet. The process comprises first dispersing metal fibers into an aqueous dispensing fluid which contains a non-carboxy containing water soluble polymer in an amount such that the viscosity of the dispensing fluid with dispersed metal fibers is suitable for wet-laying techniques. Generally, the amount of the water soluble polymer comprises from about 1 to about 5 weight percent of the aqueous dispensing fluid. In a preferred embodiment, starch is used as the water soluble polymer.

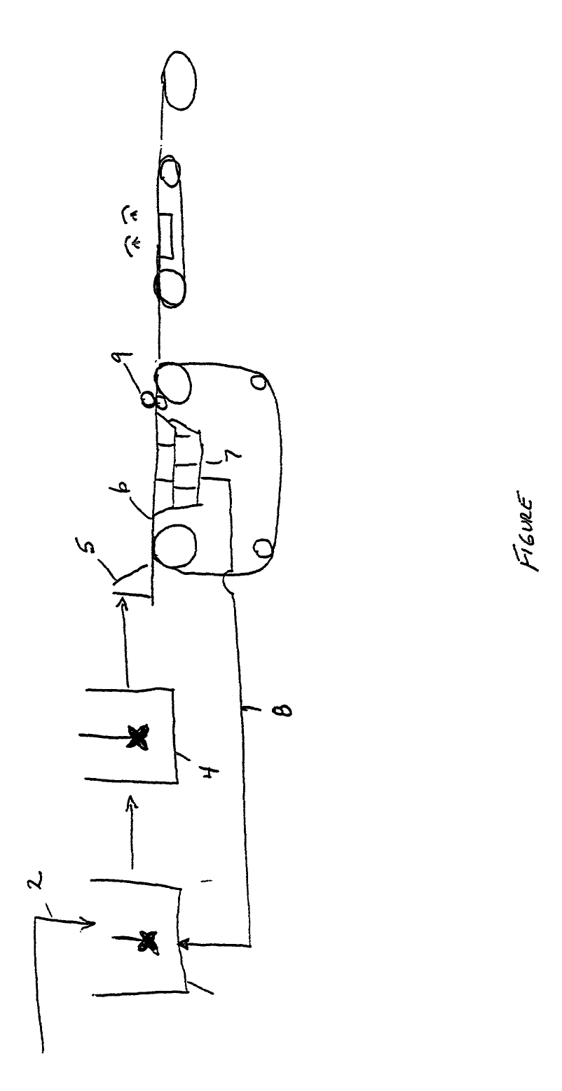

### BACKGROUND OF THE INVENTION

The present invention relates to a process for making a wet-layed metal fiber nonwoven sheet. In particular, the present invention relates to such a process which employs a unique dispersing agent in the preparation of the metal fiber sheet.

Papers comprised primarily of metal fibers have been desired by the industry for many years. Various methods have been developed for the preparation of metal fiber sheets. The manufacture of metal fiber nonwoven fabric-like paper structures on papermaking equipment has also been actively pursued due to its commercial attractiveness. Interest in such techniques is described, for example, in the chapter on metal fibers by Hanns F. Arledter in Synthetic Fibers in Papermaking, Editor O. Balestra, chapter 6, pages 118-184. See also U.S. Pat. No. 2,971,877.

The problem in making metal fiber sheets using conventional papermaking techniques is that the metal fibers tend to clump together. Before paper can be made, it is necessary to open fiber bundles to achieve individual fibers and to disperse the fibers uniformly in a fluid. With most wood pulps, the opening is not usually a difficult task. The pulp or source of fibers is placed in water and the mixture is sheared until the bundles open.

With metal fibers, both the opening of the bundles and the dispersion of the fibers in order to keep the fibers separated are difficult. Using simply normal types of mixing or shearing devices can easily damage metal fibers. When metal fibers are bent, they will remain bent and eventually will interact to form balls of tangled fibers. Paper made from fibers in this form is unacceptable.

It has been known that various additives in papermaking can lead to substantial improvements in formation. These chemicals commonly called “formation aids”, as discussed by Zhao and Kerekes in “The Effect of Suspending Liquid Viscosity on Fiber Flocculation”, Paper Formation, Vol. 26, No. 2, Tappi Journal.

Gums and mucilages constitute one class of formation aids. Examples include locust bean gum, guar gums, and deaclylated karaya gums. The prevailing school of thought on the mechanism of this formation improvement is that the gums absorb onto the fiber surfaces and thereby lower the coefficient of friction between the fibers. The easier slippage between the fibers makes them easier to disperse and maintain separation.

Another class of formation aids are the synthetic and natural polymers, with and without ionic chains. It is theorized that the use of such formation aids does not involve a reduction of surface fiction, but rather that the polymers induce a change in the rheological properties of the suspending medium and thereby induce formation improvement by this means.

In addition to gums and long chain polymers, there is what may be called a third class of formation aids, ones which relate to high shear viscosity. Studies have shown that the addition of sucrose to water at high concentrations inhibited the formation of coherent floc of suspended nylon fibers under flow conditions at which strong flocs formed in water alone. Since floc formation leads to non-uniforming in a suspension, sucrose can be considered a formation aid.

It would be of great advantage to the industry if a process for making a metal fiber sheet using conventional papermaking techniques, i.e., a wet-laying technique, could be used. A formation aid could be used, but it is important that the amount of formation aid used be limited otherwise the metal fiber product would contain large amounts of the aid, requiring a large burn-off. The process should offer efficiency and commercial viability in terms of cost.

Accordingly, it is an object of the present invention to provide a process for making a wet-layed metal fiber nonwoven sheet which is efficient and effective.

Still another object of the present invention is to provide a process for making a metal fiber nonwoven sheet using a particular dispersing agent for the metal fibers to permit formation of a good sheet.

Yet another object of the present invention is to provide a process for making a metal fiber nonwoven sheet wherein minor amounts of a water soluble polymer are added to the aqueous dispensing fluid.

These and other objects of the present invention will become apparent upon a review of the following specification, the figure of the drawing and the claims appended hereto.

### SUMMARY OF THE INVENTION

In accordance with the foregoing objectives, provided by the present invention is a process for making a wet-layed metal fiber nonwoven sheet. The process comprises first dispersing metal fibers into an aqueous dispensing fluid which contains a non-carboxy containing water soluble polymer in an amount such that the viscosity of the dispensing fluid with dispersed metal fibers is suitable for wet-laying techniques. Generally, the amount of the water soluble polymer comprises from about 1 to about 5 weight percent of the aqueous dispensing fluid, and the viscosity of the dispensing fluid, formation aid and fibers is less than 75 cps, preferably less than 25 cps. In a preferred embodiment, starch is the water soluble polymer, which can be used in amounts of about 3 weight percent.

Once the metal fibers have been dispersed in the dispensing fluid, the aqueous dispensing fluid is applied onto a screen, with the aqueous dispensing fluid then being removed to thereby form a metal fibrous sheet. The screen can be part of a conventional paper-making apparatus such as a foudrinier machine.

Among other factors, the present invention is at least partly based upon the recognition that by using a non-carboxy containing water soluble polymer, such as starch in minor amounts, e.g., less than 5 weight percent based on the weight of the aqueous dispensing fluid, a wet-layed metal fiber nonwoven sheet can be prepared using conventional papermaking techniques. Indeed, due to the small amount of water soluble polymer used, the metal fiber sheet obtained after the papermaking process generally contains at least about 95% by weight metal. Such a small amount of organics in the metal sheet is of great advantage, as the amount of organics that has to be removed during a subsequent sinter step is therefore greatly lowered.

### BRIEF DESCRIPTION OF THE FIGURE OF THE DRAWING

The FIGURE of the Drawing schematically depicts a process of the present invention useful in making a metal fiber sheet by a wet-laying technique.

### DETAILED DESCRIPTION OF THE PREFERRED EMBODIMENTS

The process of the present invention employs a non-carboxy containing water soluble polymer to aid in dispersing metal fibers into an aqueous dispensing fluid. The dry metal fibers are added to the aqueous dispensing fluid, to which the non-carboxy containing water soluble polymer is also added. Through mixing, the metal fibers are dispersed.

Among the water soluble polymers useful for the present invention are polyvinyl alcohol, starch or cellulose ethers, such as methyl, ethyl or propyl ethers. In general, any water soluble polymer can be used, which will have the required functional groups to render them water soluble. Generally, the water soluble polymer comprises from 1 to 5 weight percent of the aqueous dispensing fluid. In a preferred embodiment, starch is the water soluble polymer used as the dispersing aid, and is generally used in an amount ranging from 3 to 4 weight percent based upon the weight of aqueous dispensing fluid.

The water soluble polymer can be added directly to the aqueous dispensing fluid, generally before the metal fiber is added. This will allow the water soluble polymer, dissolved in the aqueous dispersing fluid, to immediately begin to interact with the dry metal fiber once added. While the water soluble polymer allows the dry fiber to disperse, it also aids in the formation of the metal fiber web by maintaining separation of the metal fibers. The fact that such a small amount of a water soluble polymer such as starch can be used to effectively maintain separation is quite surprising.

The viscosity of the solution used in making the sheet is generally less than 75 cps, which is necessary for purposes of a paper-making process. More preferably, however, the viscosity is in the range of from 10 to 50 cps, and most preferably in the range of from 15 to 35 cps.

The agitator used can be any suitable agitator which will permit dispersion of the metal fibers. Generally, it is prepared to use a non-stapling agitator as is known in the art. Such an agitator would have a leading edge diameter greater than the length of the fibers to prevent the fibers from wrapping around the agitator blades.

While the present process is useful for 100% metal fibers, various amounts of cellulosic fibers can also be added together with the metal fibers to create a blend. Some synthetic fibers can also be added, if desired.

The metal fibers can be any useful metal fiber, with nickel and stainless steel fibers being most preferred. The stainless steel fibers can be stainless steel 304 fibers, stainless steel 16 fibers and stainless steel Hastelloy X fibers. Nickel and stainless steel fibers are most preferred because their potential uses are exceptional.

Conventional additives can also be added to the aqueous dispensing fluid. Such additives would include, for example, a biocide to inhibit microorganism growth in dispensing fluid. Other conventional additives can also be added.

Once the metal fibers have been dispersed in the aqueous dispensing fluid, the dispensing fluid is then applied to a screen as is conventional in a papermaking process. The screen can be made of any suitable or conventional material. The aqueous dispensing fluid is then removed in order to form the metal fiber sheet. Generally this is done through vacuum suction of the fluid through the screen. In a preferred embodiment, the process of the present invention is conducted in a closed system where the dispensing fluid removed from the metal fibers is recycled and reused.

Turning now to the FIGURE of the Drawing, a mixing vessel 1 contains the aqueous dispensing fluid together with the non-carboxy containing water soluble polymer such as starch. The dry metal fiber is added via 2 into the dispensing fluid. Mixing is achieved by a stirrer 3. Generally, the mixer 3 is an agitator that does not induce fiber stapling, as is known in the art. The mixing continues until the desired fiber separation is achieved.

In a preferred embodiment, the aqueous dispensing fluid containing the dispersed metal fibers is passed to a second mixing tank 4. The additional mixing is optional, but does insure good formation in the subsequent sheet. It is therefore preferred that a plurality of such mixing tanks be employed to insure good dispersion and formation of the metal sheet.

The aqueous dispensing fluid is then passed to a headbox 5, through which the aqueous dispensing fluid containing the metal fibers is applied to a continuous screen 6. A vacuum system 7 is generally used to remove the aqueous dispensing fluid in order to form the metal fiber sheet on the screen. In a preferred embodiment, the removed aqueous dispensing fluid is then recycled to the mixing tank 1 via line 8.

The formed metal fiber sheet is then passed through press rolls 9, and can then be calendared and dried as is conventional in the papermaking industry. Despite the use of such a small amount of water soluble polymer, the residue is sufficient to provide sufficient strength to the metal fiber sheet so that such subsequent handling can occur without incident.

The final step is a sintering step which can be conducted at optimum temperatures in an inert or reducing atmosphere. The sintering step introduces the strength to the metal fiber paper, as well as burns off the various organics contained in the metal fiber paper. The sintering step generally involves heating the paper at a temperature of from 1500-1200° F. for a time necessary to burn off the organics. The sintering step is preferably conducted in a hydrogen atmosphere. If desired, a prior pyrolysis step can be conducted at a lower temperature to initially burn off organics. However, the pyrolysis step does not impart the necessary strength to the paper, and should be followed by the sintering step at the higher temperature of from 1500-2000° F. to burn off any remaining organics and to provide the desired strength to the paper. The resulting fiber paper contains at least about 95 weight percent metal, and more preferably at least 99 weight percent metal.

The resulting metal fiber sheet is useful in many different applications. For example, the metal fiber sheet can be used as a battery electrode. Nickel fiber is preferred for such an application. The metal fiber sheets can also be used as fluid filters. The filters can be useful for hydraulic fluids, water or oil. The metal fiber sheets can also be used as gas filters, for example in the filtering of air or exhaust gases. The applications are many, and with the use of the present invention in the preparation of metal fiber sheets, the availability of such sheets in an economic fashion will be increased.

The invention will be illustrated in greater detail by the following specific example. It is understood that this example is given by way of illustration and is not meant to limit the disclosure of the claims to follow. All percentages in the examples, and elsewhere in the specification are by weight unless otherwise specified.

### EXAMPLE

A starch solution was made by cooking an aqueous slurry of corn starch. Starch is an unusual material in that the solid is in the form of a powder called flour. This can be slurried in cold water. When heated to 100° C. the particles swell and then burst to form a starch solution. The fluid viscosity will increase as the starch chains are released by the rupturing of the starch granules. The process is very much like the process of making a gravy from water, flour, and meat drippings. The starch solution contained 1.5 wt % starch.

The metal fibers in this example were made of nickel metal. The fibers were 8 micrometer and 0.25 inch long. The fibers were added to eight liters of the 1.5% cooked starch solution. The viscosity of the starch solution with the fibers added was 16.8 centipoise. 20 grams of the fibers were dispersed in the starch solution using a non-stapling agitator. The agitator had a leading edge with a diameter greater than length of the fibers.

The mixing chamber was a five gallon cooking pot which had been equipped with four baffles. The baffles were one inch wide and ten inches long. Since the fiber length was less than the diameter of the leading edge of the agitator, it could not staple around the agitator blade. This agitator was rotated at 1090 RPM. I found that the dispersion of the fibers occurred quite rapidly. It was not necessary to mix the fibers for more than one minute.

Eight liters of the starch solution were used to disperse the 20 grams of metal fibers. No additional water or starch solution was added to the handsheet mold. The fibers were dispersed at 0.25%. consistency and the handsheets were made at the same consistency.

The handsheet was formed by draining the starch solution through a forming wire. The handsheet was wet pressed between wet felts at 42 pli to remove excess solution. The paper was dried on a steam heated dryer can with a surface temperature of about 220° F. An emulsion of oleic acid and lecithin was coated on the surface of the heated surface to prevent sticking. After the sheet was dry it was weighed to determine the amount of starch that had been carried along with the fibers. It was learned that about one gram of starch was retained by the fibers. Upon drying of the sheet, this material acted as a binder. The paper contained about 95% metal and about 5% starch.

While the invention has been described with preferred embodiments, it is to be understood that variations and modifications may be resorted to as will be apparent to those skilled in the art. Such variations and modifications are to be considered within the purview and the scope of the claims appended hereto.

What is claimed is:

1. A process for making a wet-layed metal fiber non-woven sheet which comprises
(a) dispersing metal fibers and a non-carboxy containing water soluble polymer into an aqueous dispensing fluid in an amount such that the viscosity of the dispensing fluid with dispersed metal fibers is suitable for wet laying techniques,
(b) applying the aqueous dispersing fluid with dispersed metal fibers onto a screen, and
(c) removing the aqueous dispersing fluid to thereby form a metal fiber sheet.

2. The process of claim 1, wherein the water soluble polymer contained in the aqueous dispensing fluid comprises polyvinyl alcohol, starch or a cellulose ether.

3. The process of claim 2, wherein the water soluble polymer comprises from 1 to 5 weight percent of the aqueous dispensing fluid.

4. The process of claim 2, wherein the amount of water soluble polymer contained in the aqueous dispensing fluid is in the range of from about 3 to 4 weight percent.

5. The process of claim 2, wherein the water soluble polymer contained in the aqueous dispensing fluid comprises starch.

6. The process of claim 5, wherein the aqueous dispensing fluid further comprises a biocide to inhibit microorganism growth in the dispensing fluid.

7. The process of claim 1, wherein the metal fibers comprise nickel or stainless steel fibers.

8. The process of claim 7, wherein the metal fibers comprise nickel fibers.

9. The process of claim 7, wherein the metal fibers comprise stainless steel fibers.

10. The process of claim 1, wherein the aqueous dispensing fluid is recycled.

11. The process of claim 1, wherein the metal fiber sheet is comprised of at least 95% by weight metal.

12. A wet-layed, non-woven metal fiber web comprising a non-carboxy containing water soluble polymer at the interstices of the metal fibers in an amount such as to provide the sheet with integrity sufficient to permit handling in subsequent converting operations such as calendaring or sintering.

13. The metal fiber sheet of claim 12, wherein the metal fibers comprise stainless steel or nickel fibers.

14. The metal fiber sheet of claim 12, wherein the metal fibers comprise stainless steel fibers.

15. The metal fiber sheet of claim 12, wherein the metal fibers comprise nickel fibers.

16. The metal fiber sheet of claim 12, wherein the water soluble polymer is comprised of polyvinyl alcohol or starch, carboxymethyl cellulose.

17. The metal fiber sheet of claim 12, wherein the water soluble polymer at the interstices of the metal fibers comprises starch.

18. A wet-layed non-woven metal fiber sheet made by the process of claim 1.

19. The metal fiber sheet of claim 18, wherein the sheet is comprised of at least 95% metal.

20. A wet-layed non-woven metal fiber sheet made by the process of claim 5.

21. The metal fiber sheet of claim 20, wherein the sheet comprises at least 95% metal.

22. A wet-layed non-woven metal fiber sheet made by the process of claim 7.

23. The metal fiber sheet of claim 22, wherein the sheet comprises at least 95% metal.

24. A wet-layed non-woven metal fiber sheet which has been sintered and comprises at least 99% by weight metal with the remainder being carbon residual from the sintering process.

25. A wet-layed non-woven metal fiber sheet which comprises at least 99% by weight metal.

26. A battery electrode manufactured using the wet-layed non-woven metal sheet of claim 24.

27. A battery electrode manufactured using the wet-layed non-woven metal sheet of claim 25.

28. A fluid filter manufactured using the wet-layed non-woven metal sheet of claim 24.

29. A fluid filter manufactured using the wet-layed non-woven metal sheet of claim 25.

30. A gas filter manufactured using the wet-layed non-woven metal sheet of claim 25.
